(19) United States
(12) Patent Application Publication
(10) Pub. No.: US 2007/0047507 A1
(43) Pub. Date: Mar. 1, 2007

(54) Home agent and mobile node

(75) Inventors: Keiichi Nakatsugawa, Kawasaki (JP); Junichi Suga, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/280,446

(22) Filed: Nov. 16, 2005

(30) Foreign Application Priority Data
Aug. 30, 2005 (JP) 2005-250096

(51) Int. Cl. H04Q 7/24

(52) U.S. Cl. 370/338; 370/401

(57) ABSTRACT

Deterioration of communication quality in mobile communication through an IP network caused by a shortage of transfer capacity in a home agent or a capacity shortage in an access channel is prevented, in a mobile IP network. The mobile IP network includes a home agent and a mobile node of which location is registered in the home agent, the home agent includes a storage unit for storing channel capacity information; a registration unit for deciding based on bandwidth information in a registration request transmitted from the mobile node, whether or not the requested registration is acceptable by referring to the channel capacity information stored in the storage unit; and a transfer unit for transferring to a care-of address a packet destined to the mobile node which is decided registrable by the registration unit.

### CROSS-REFERENCE TO RELATED APPLICATIONS

This application is based upon and claims the benefit of priority from the prior Japanese Patent Application No. 2005-250096, filed on Aug. 30, 2005, the entire contents of which are incorporated herein by reference.

### BACKGROUND OF THE INVENTION

1. Field of the Invention

The present invention relates to improvement of communication quality in mobile communication in an IP network.

2. Description of the Related Art

Mobile IP is known as a protocol to achieve mobility in the IP network. In Mobile IP, a mobile node (MN) registers in a home agent (HA) the relationship of correspondence between a home address (HoA) which is fixedly assigned to the mobile node and a care-of address (CoA) which is temporarily used when the mobile node MN moves in a foreign domain.

A packet transmitted from a correspondent node (CN) a node of other communication party, to the HoA of the mobile node MN is received by the home agent HA by proxy. The home agent HA then tunnels the received packet to the care-of address CoA of the mobile node MN. Thus, the mobile node MN can communicate with the correspondent node CN even the mobile node MN is located in the foreign domain.

Additionally, in Mobile IP, two protocols of Mobile-IPv4 and Mobile-IPv6 are defined. Although the format structures are different from each other, the basic operation is the same.

Here, in a conventional home agent HA, generally the number of users to which mobility can be supported, namely the number of registrable mobile nodes MN, has an upper limit due to a memory capacity mounted on the home agent HA. In other words, the home agent HA accepts registration if the number of registration does not exceed the upper limit of the registrable mobile nodes MN, without taking account of other factors.

This causes the problem of deterioration in communication quality.

Namely, as a cause of communication quality deterioration, first, a shortage of transfer capability of the home agent HA is considered.

FIG. 1 shows a state of location registration from the mobile node MN to the home agent HA. Here, for the sake of explanation, it is assumed that the home agent HA can register two mobile nodes MN1 and MN2, and that the traffic transfer capacity of the home agent HA is 100 Mbps. Each mobile node MN1, MN2 transmits a registration request message (Registration Request in case of Mobile IPv4, or Binding Update in case of Mobile IPv6), so as to request the home agent HA to register each care-of address CoA (RQ1, RQ2).

The home agent HA can accept both registration requests from the mobile nodes MN1, MN2. Accordingly, the home agent HA permits the registration, and stores each care-of address CoA as binding cache (BC). The home agent HA then transmits each registration reply message ACK1, ACK2 (Registration Reply in Mobile IPv4, or Binding Acknowledgement in Mobile IPv6), indicating successful registration.

FIG. 2 shows an example of the binding cache BC generated in the home agent HA. In FIG. 2, both mobile nodes MN1, MN2 belong to the same home agent (100.0.0), and have moved to different care-of addresses (200.0.0, 300.0.0), respectively.

FIG. 3 shows an exemplary case of starting communication from mobile nodes MN1, MN2 to the respective correspondent nodes CN1, CN2, after the registration shown in FIG. 1 is completed.

Although depending on the communication content, for example, when intending to perform high-speed file transfer or moving picture streaming with high image quality, a large amount of traffic may possibly be produced. The example shown in FIG. 3 indicates a state such that total traffic of 110 Mbps is generated, namely, 50 Mbps from the correspondent node CN1 to the mobile node MN1, and 60 Mbps from the correspondent node CN2 to the mobile node MN2 flow into the home network in which the home agent HA exists.

However, a total throughput with which the home agent HA can perform transfer processing to the domains the MN1 and MN2 moved to is 100 Mbps. Therefore, 10 Mbps traffic cannot be processed, and packet discard, etc. occurs. As a result, in the example shown in FIG. 3, each traffic amount which finally reaches the mobile nodes MN1, MN2 becomes 45 Mbps, while packets for 5 Mbps are discarded. This causes communication quality deterioration such as the occurrence of retransmission, disconnection of communication, and deterioration in the image/voice quality.

Further, in case of a home location register, etc. in a cellular portable telephone network, only location management including location registration/update of mobile terminals is to be performed. In contrast, in case of the home agent HA in Mobile IP, it is necessary to perform transfer processing of communication traffic, in addition to location management. Therefore, when a high load condition occurs in the home agent HA caused by traffic inflow exceeding the transfer capacity, not only the above-mentioned communication quality deterioration due to discarded data packets occurs: As to a registration request message transmitted from the mobile node MN, discard or processing delay may also occur. This causes a risk of producing further communication quality deterioration due to incorrect transfer of packets to the domain in which the mobile node MN has been located previously, disconnection of the registration itself, etc.

Next, the problem of communication quality deterioration caused by a shortage of the communication channel capacity in the network is considered hereafter.

FIG. 4 shows a diagram illustrating the problem in the case the channel capacity in the halfway of the network is small. In FIG. 4, the home agent HA already accepted the registration of the mobile node MN1, and 50 Mbps traffic is being transmitted from the correspondent node CN1 to the mobile node MN1. The mobile node MN1 is connected to the IP network (not shown) via the network NW1 as an access channel. Here, since the channel capacity of the network NW1 is as small as 20 Mbps, even when 50 Mbps traffic flows into the network NW1 via the home agent HA, packet discard or delay is produced at the entry of the network NW1 or the inside thereof. As a result, only 20 Mbps traffic can reach the mobile node MN1. Thus, undesirably, communication quality deterioration is also produced.

In the mobile communication, wireless networks such as a cellular network and a wireless LAN are normally used as access channels. However, the channel capacity of such a network is small, as compared with the channel capacity of a wired network provided by a communication carrier. Therefore, it is sufficiently probable that communication quality deterioration caused by the above-mentioned shortage of the communication channel capacity be produced.

Here, as a technique related to the mobile IP network, an invention has been disclosed in the official gazette of the Japanese Unexamined Patent Publication No. 2005-26941 (patent document 1). According to the invention disclosed in the above patent document 1, necessity to suspend transfer is decided based on the quality information of the connected channel. When it is decided necessary, the transfer processing is suspended for a time needed. With this, a delay which may be produced in the response of location registration is avoided.

Also, according to the official gazette of the Japanese Unexamined Patent Publication No. 2003-163973 (patent document 2), a location registration procedure of a mobile terminal (mobile node) is disclosed, so as to obtain an effect such that data transfer speed is hardly decreased even when the accommodated mobile nodes increase in number.

However, in the above-disclosed patent documents 1, 2, the above-mentioned problem of communication quality deterioration in the mobile IP network has not been pointed out either.

### SUMMARY OF THE INVENTION

Accordingly, it is an object of the present invention to provide a home agent and a mobile node avoiding the aforementioned deterioration of communication quality in the mobile IP network, which may be caused by a shortage of transfer capacity in the home agent, or a capacity shortage in an access channel.

As a method for solving the above-mentioned problem, in a first aspect of the present invention, a home agent in a mobile IP network is disclosed. The home agent includes: a storage unit storing an upper limit value of a throughput with which transfer processing can be performed, as self-transfer capacity information; based on bandwidth information requested for registration which is transmitted from a mobile node, a registration unit deciding whether or not the registration is acceptable by referring to the upper limit value of the throughput with which transfer processing can be performed, being stored in the storage unit; and a transfer unit transferring to a care-of address a packet destined to the mobile node which is decided registrable by the registration unit.

As another method for solving the above-mentioned problem, in a second aspect of the present invention, a home agent in a mobile IP network includes: a storage unit storing channel capacity information; based on bandwidth information requested for registration which is transmitted from a mobile node, a registration unit deciding whether or not the registration is acceptable by referring to the channel capacity information stored in the storage unit; and a transfer unit transferring to a care-of address a packet destined to the mobile node which is decided registrable by the registration unit.

Preferably, the above mobile node uses a plurality of applications, and when a registration request is initiated from the mobile node which uses the plurality of applications, the registration unit decides whether or not the registration is acceptable for each of the plurality of applications, based on the bandwidth information requested for registration.

When a registration is initiated from a mobile node using a plurality of communication channels, preferably, the registration unit decides whether or not the registration is acceptable by dividing the requested bandwidth for each of the plurality of channels, based on the requested bandwidth information and the channel capacity information.

When the registration is initiated from a mobile node which uses a plurality of communication channels and a plurality of applications, preferably, the registration unit decides whether or not the registration is acceptable on an application-by-application basis, based on the requested bandwidth information and the channel capacity information.

The channel capacity information of the communication channel to be stored in the storage unit may be acquired from the mobile node.

Also, it may be possible to configure so that the registration unit discards a packet not satisfying a transfer condition which is decided registrable in the registration unit.

As a method for solving the aforementioned problem, in a third aspect of the present invention, a mobile node in a mobile IP network is disclosed. The mobile node includes: a registration unit generating a registration message including at least information of a requested bandwidth, and requesting the home agent to register; and a storage unit storing a binding cache. According to the result of a registration response from the home agent in response to the registration request to the home agent, the registration unit instructs the storage unit to generate and store a binding cache to be referred to at the time of packet transmission.

In a registration message for initiating a registration request from the registration unit to the home agent, it may also be possible to include communication channel capacity information.

Further, in the registration message for initiating the registration request from the registration unit to the home agent, it is possible to include application information.

Still further, by use of a plurality of communication channels, it may also be possible that the registration unit registers to the home agent by use of a registration message including the information of the plurality of communication channels.

Further, it may also be possible that the registration unit registers to the home agent by use of a registration message including communication channel information of the corresponding communication channel, according to the priority of the plurality of communication channels.

Still further, it may also be possible that the mobile node uses a plurality of applications, and the registration unit registers to the home agent by use of a registration message including the requested bandwidth information and the application information.

It may also be possible that the registration unit registers to the home agent by use of a registration message including communication channel information of the corresponding communication channel, according to the priority of the plurality of applications.

As a method for solving the aforementioned problem, in a fourth aspect of the present invention, a mobile IP network system including a home agent and a mobile node of which location is registered in the home agent is disclosed. In the mobile IP network, the home agent includes: a storage unit storing channel capacity information; based on the bandwidth information requested for registration being transmitted from the mobile node, a registration unit deciding whether or not the registration is acceptable by referring to the channel capacity information stored in the storage unit; and a transfer unit transferring to a care-of address a packet destined to the mobile node which is decided registrable by the registration unit. Further, the mobile node includes: a registration unit generating a registration message including at least the requested bandwidth information, and requesting the home agent to register; and a storage unit storing a binding cache, and according to the result of a registration response from the home agent in response to the registration request to the home agent, the registration unit instructs the storage unit to generate and store a binding cache to be referred to at the time of packet transmission.

Further scopes and features of the present invention will become more apparent by the following description of the embodiments with the accompanied drawings.

### BRIEF DESCRIPTION OF THE DRAWINGS

FIG. 1 shows a state of location registration from the mobile node MN to the home agent HA.

FIG. 2 shows an example of a binding cache BC generated in the home agent HA.

FIG. 3 shows an exemplary case of starting communication from mobile nodes MN1, MN2 to the respective correspondent nodes CN1, CN2, after the registration shown in FIG. 1 is completed.

FIG. 4 shows a diagram illustrating the problem in the case the channel capacity in the halfway of the network is small.

FIG. 5 shows a diagram illustrating a first embodiment of the present invention, in which the present invention is explained corresponding to the description of FIG. 1.

FIG. 6 shows an example of retaining an upper limit value of throughput with which transfer processing can be performed, as transmission capacity information of the home agent HA.

FIG. 7 shows an example of a generated binding cache BC including a requested bandwidth.

FIG. 8 shows an example of a registration request message shown in FIG. 5, in the case of Mobile IPv4.

FIG. 9 shows an example of a registration request message shown in FIG. 5, in the case of Mobile IPv6.

FIG. 10 shows a diagram illustrating avoidance of communication quality deterioration due to packet discard, etc. in the home agent HA.

FIG. 11 shows a diagram illustrating a method according to an embodiment of the present invention, for avoiding communication quality deterioration due to a shortage of communication channel capacity.

FIG. 12 shows a diagram illustrating that the home agent HA retains the relationship of correspondence between the channel capacity and a network into which the mobile node MN moves.

FIG. 13 shows an example of a registration request message in which the channel capacity information is reported from the mobile node MN in FIG. 11, in the case of Mobile IPv4.

FIG. 14 shows an example of a registration request message in which the channel capacity information is reported from the mobile node MN in FIG. 11, in the case of Mobile IPv6.

FIG. 15 shows a case that a bandwidth requested from the mobile node MN is 20 Mbps, further in regard to FIG. 11.

FIG. 16 shows a binding cache BC including channel capacity information generated in the home agent HA.

FIG. 17 shows a diagram illustrating an example of avoiding communication quality deterioration due to packet discard, etc. in the home agent HA and the network.

FIG. 18 shows an exemplary case that the mobile node MN1 is connected to the network using a plurality of communication channels.

FIG. 19 shows an example of a binding cache BC including two care-of addresses CoA.

FIG. 20 shows an example of a table in which channel capacity information for each network is separately retained.

FIG. 21 shows an example of a table in which the binding cache BC and the channel capacity information are retained in an integrated form.

FIG. 22 shows an example of a table retaining the priority of the communication channels used by the mobile node MN1 in the self-mobile node MN1.

FIG. 23 shows an exemplary case that the mobile node MN1 executes a plurality of communication-applications.

FIG. 24 shows an example of the generated binding cache BC in the embodiment shown in FIG. 23.

FIG. 25 shows an example of a registration request message including application information, in the case of Mobile IPv4

FIG. 26 shows an example of a registration request message including application information, in the case of Mobile IPv6.

FIG. 27 shows an example of an application priority table which the mobile node MN1 requests to register.

FIG. 28 shows an exemplary case of using a plurality of applications further, taking communication channel capacity into account.

FIG. 29 shows an example of the generated binding cache BC in the embodiment shown in FIG. 28.

FIG. 30 shows an exemplary case of using a plurality of applications through a plurality of communication channels, taking the channel capacity of each communication channel into account.

FIG. 31 shows an exemplary case of a binding cache BC, with the channel capacity information as shown in FIG. 20 retained individually, in the embodiment shown in FIG. 30.

FIG. 32 shows an exemplary case that the channel capacity information is integrated into the binding cache BC, in the embodiment shown in FIG. 30.

FIG. 33 shows an exemplary configuration of the home agent HA according to the present invention.

FIG. 34 shows a flowchart diagram of the registration processing as shown in FIG. 5, to be performed in the home agent HA having the exemplary configuration shown in FIG. 33.

FIG. 35 shows a flowchart diagram of the registration processing in the embodiments shown in FIGS. 11, 15, to be performed in the home agent HA having the exemplary configuration shown in FIG. 33.

FIG. 36 shows an exemplary configuration of the mobile node MN according to the present invention.

FIG. 37 shows a flowchart diagram of the registration processing in the embodiment shown in FIG. 5, to be performed in the mobile node MN having the exemplary configuration shown in FIG. 36.

FIG. 38 shows a flowchart diagram of the registration processing explained in FIG. 18, to be performed in the mobile node MN having an exemplary configuration shown in FIG. 36.

FIG. 39 shows a flowchart diagram of the registration processing explained in FIG. 23, to be performed in the mobile node MN having an exemplary configuration shown in FIG. 36.

FIG. 40 shows a flowchart diagram of the registration processing explained in FIG. 30, to be performed in the mobile node MN having an exemplary configuration shown in FIG. 36.

FIG. 41 shows a sequence diagram when the mobile node MN starts communication.

FIG. 42 shows a sequence diagram when the correspondent node CN starts communication.

### DETAILED DESCRIPTION OF THE INVENTION

The preferred embodiments of the present invention are described hereinafter referring to the charts and drawings. However, it is noted that the preferred embodiments are described for the sake of better understanding of the present invention, and therefore, the technical scope of the present invention is not limited to the embodiments described below.

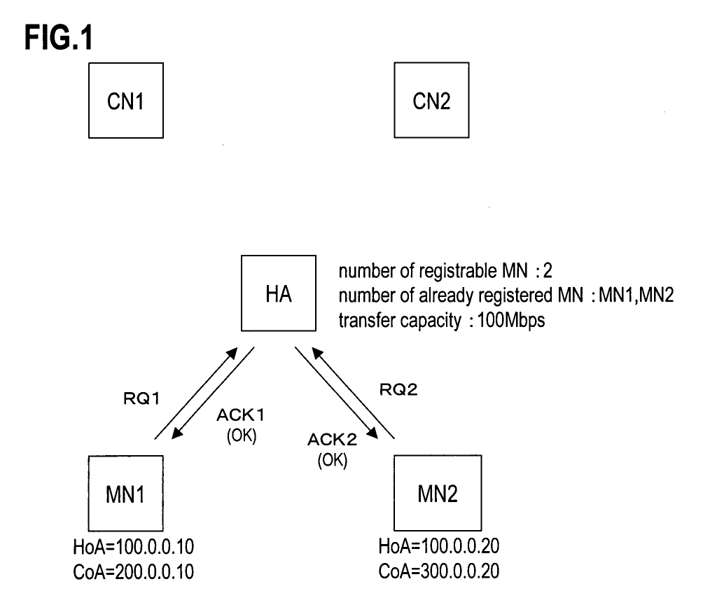

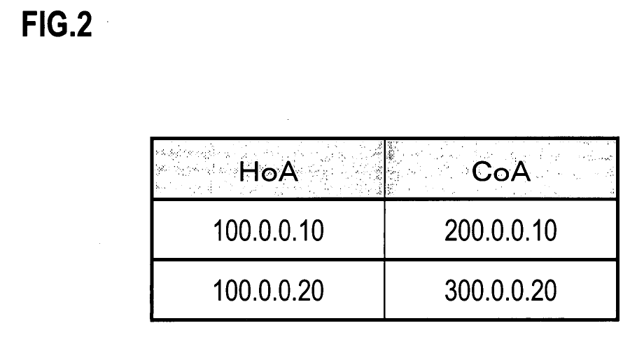

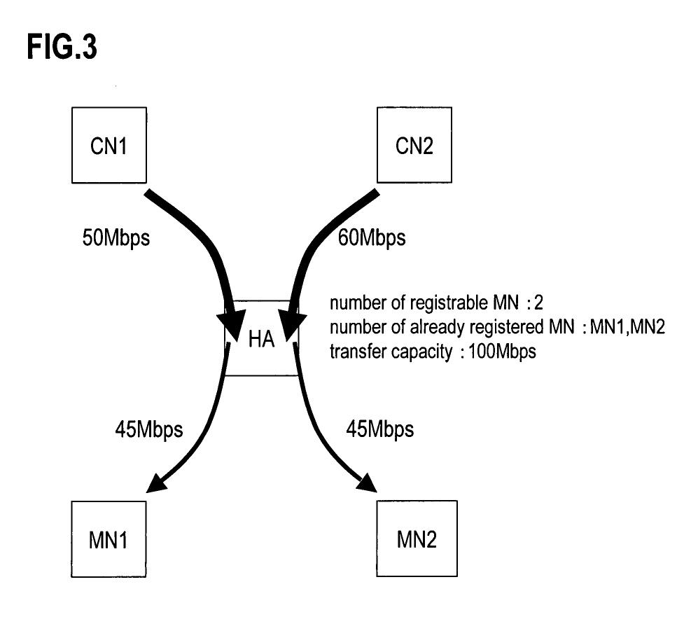

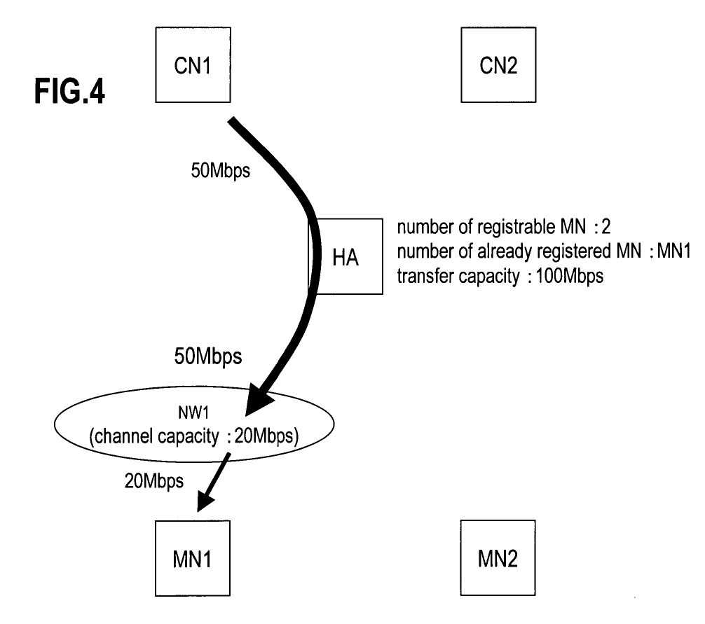

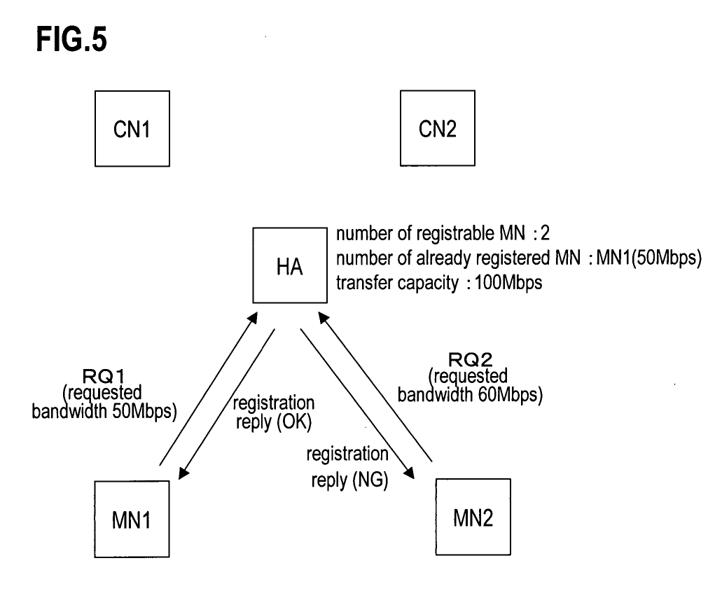

FIG. 5 shows a diagram illustrating a first embodiment of the present invention. The present invention is explained corresponding to the explanation of FIG. 1.

Here, registration of care-of addresses CoA is performed in order of the mobile nodes MN1, MN2, to the home agent HA. First, the mobile node MN1 includes a requested bandwidth (here, 50 Mbps) necessary for communication into a registration request (RQ1) message.

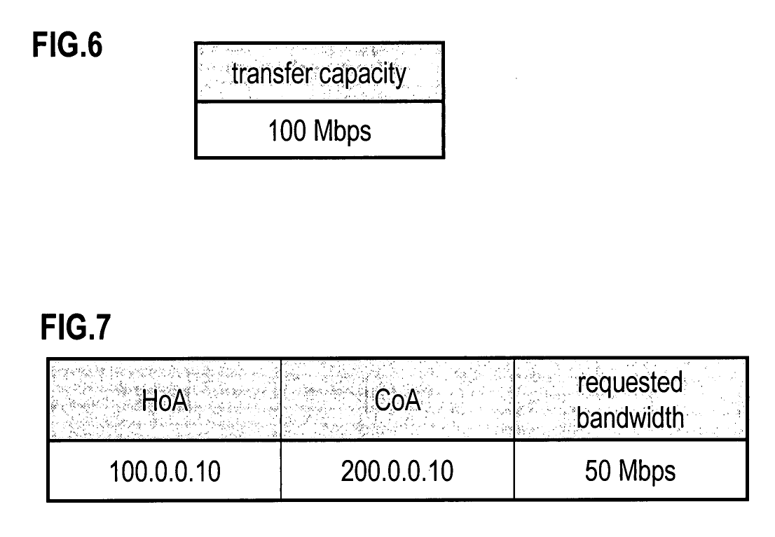

As shown in FIG. 6, the home agent HA retains, in a storage medium such as a nonvolatile memory, an upper limit value of throughput with which transfer processing can be performed (100 Mbps in the example shown in FIG. 6), as transfer capacity information of the self-home agent HA.

The home agent HA decides whether the requested bandwidth of 50 Mbps requested from the mobile node MN1 can be processed, referring to other already accepted bandwidths at that time and the transfer capacity, and accepts registration when the request is acceptable. At this time, a binding cache BC including the requested bandwidth is generated, for example, as shown in FIG. 7. The home agent HA transmits to the mobile node MN1 a registration reply message, indicating the registration is successfully completed (OK).

Consecutively, a registration request is initiated from the mobile node MN2, with a requested bandwidth of 60 Mbps specified therein (RQ2). The home agent HA has already accepted the request of 50 Mbps in regard to the mobile node MN1. Since the self-transfer capacity is 100 Mbps, the home agent HA decides that communication quality will be deteriorated if the home agent HA accepts the registration request of 50 Mbps from the mobile node MN2.

Therefore, the home agent HA rejects the registration for the mobile node MN2 (NG). As a result, a binding cache BC in regard to the mobile node MN2 is not generated.

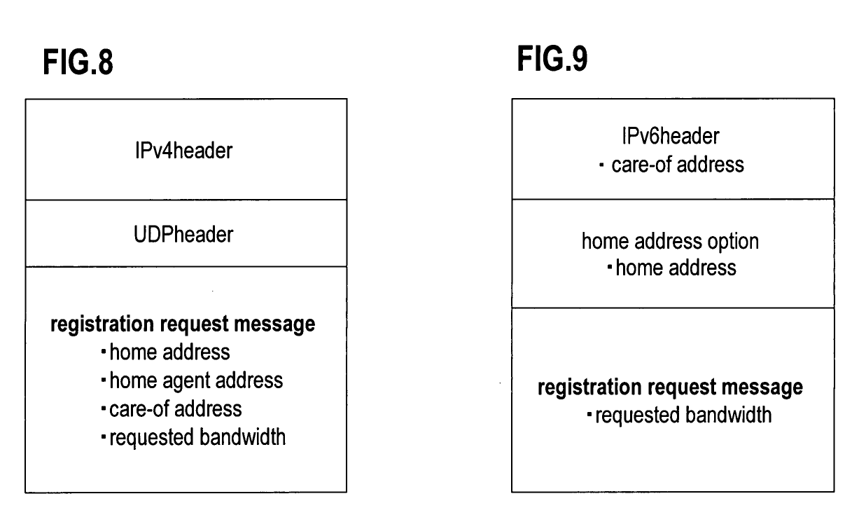

FIGS. 8, 9 show examples of a registration request message shown in FIG. 5 in the cases of Mobile IPv4 and Mobile IPv6, respectively.

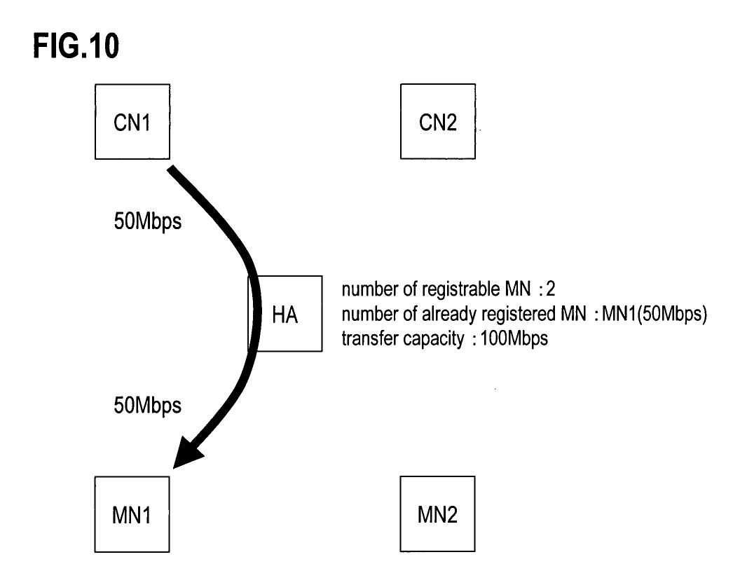

As a result, as shown in FIG. 10, only the communication traffic of 50 Mbps between the mobile node MN1 and the correspondent node CN1 passes through the home agent HA. Thus, deterioration in the communication quality due to packet discard, etc. can be avoided in the home agent HA.

Additionally, in the above state, the home agent HA can accept registration for another node, as long as the bandwidth requested therefrom is no greater than 50 Mbps.

As such, in the registration request, the mobile node MN declares a necessary bandwidth, in addition to the care-of address CoA. Also, the home agent HA performs an acceptance decision on a basis of the transfer capacity, the already accepted bandwidths, and the bandwidth requested from the mobile node MN. With this, the home agent HA can support mobility, avoiding the occurrence of communication quality deterioration.

Next, an embodiment method for avoiding communication quality deterioration caused by a shortage of communication channel capacity in the network will be described hereafter.

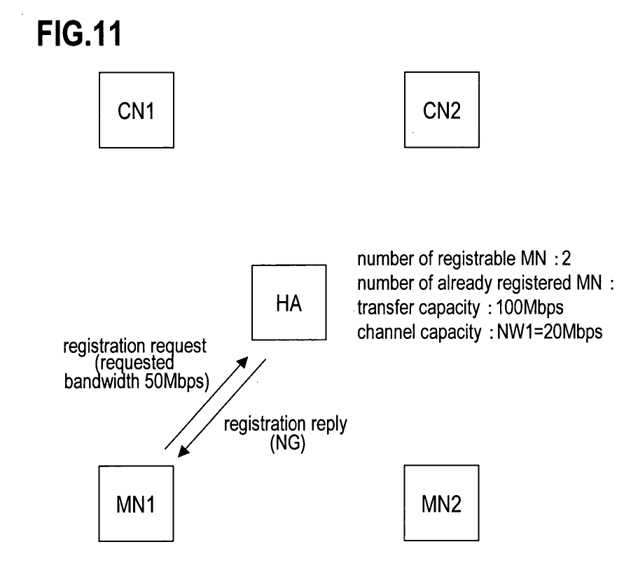

FIG. 11 shows a diagram illustrating a method for avoiding communication quality deterioration due to a shortage of communication channel capacity, according to an embodiment of the present invention.

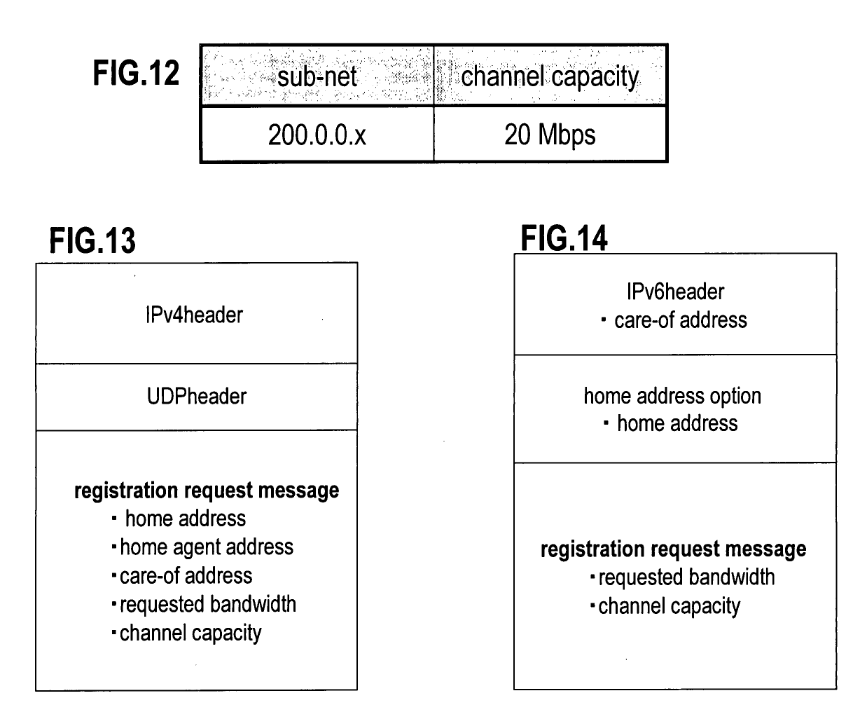

In FIG. 11, first, the mobile node MN1 includes, in a registration request message, a requested bandwidth necessary for communication (here, 50 Mbps). As shown in FIG. 12, the home agent HA retains, in a storage medium such as a nonvolatile memory, the relationship of correspondence between the channel capacity and a network (here, NW1, of which subnet address is assumed as 200.0.0.x) into which the mobile node MN moves. Or, when the mobile node MN1 knows the channel capacity of the network NW1 from an access channel type in use, etc., the mobile node MN1 may inform the home agent HA of the channel capacity information, by including in the registration request message.

FIGS. 13, 14 show examples of a registration request message in which the channel capacity information is reported from the mobile node MN in FIG. 11, in the cases of Mobile IPv4 and Mobile IPv6, respectively.

First, the home agent HA checks whether or not the channel capacity can satisfy the requested bandwidth. In the example shown in FIG. 11, the channel capacity of the network NW1 is 20 Mbps, which does not satisfy the requested bandwidth of 50 Mbps, the home agent HA rejects the registration.

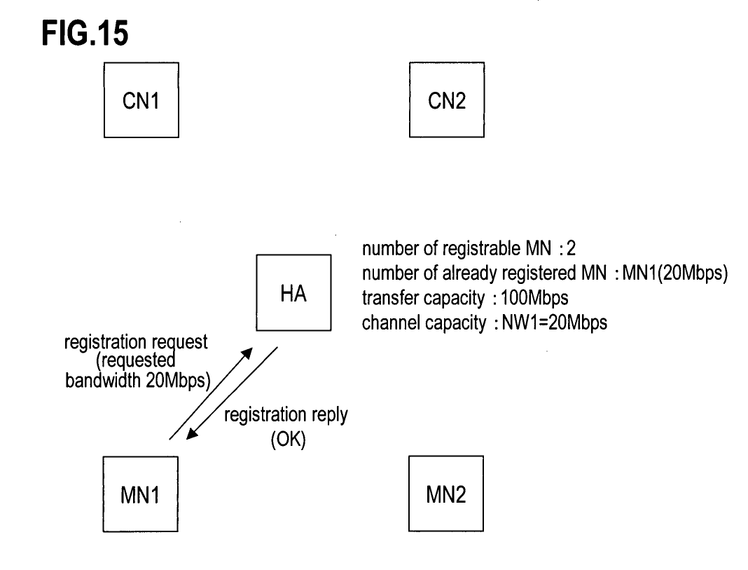

On the other hand, as shown in the example of FIG. 15, if the bandwidth requested from the mobile node MN1 is 20 Mbps, the check in the home agent HA in regard to whether the channel capacity satisfies the requested bandwidth results in a success (i.e. satisfied). The home agent HA further decides whether the requested bandwidth can be processed, by referring to the other bandwidths already accepted, and the transfer capacity.

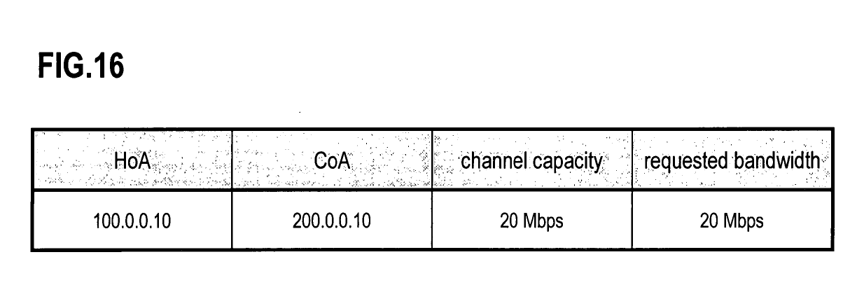

Here, since the transfer capacity is 100 Mbps, while the other already accepted bandwidth is zero, the home agent HA decides it is able to process, and accepts the registration accordingly. The home agent HA may also generate a binding cache BC similar to that shown in FIG. 7. In case the channel capacity of the network NW1 is notified from the mobile node MN1, the home agent HA may generate a binding cache BC including channel capacity information, as exemplarily shown in FIG. 16.

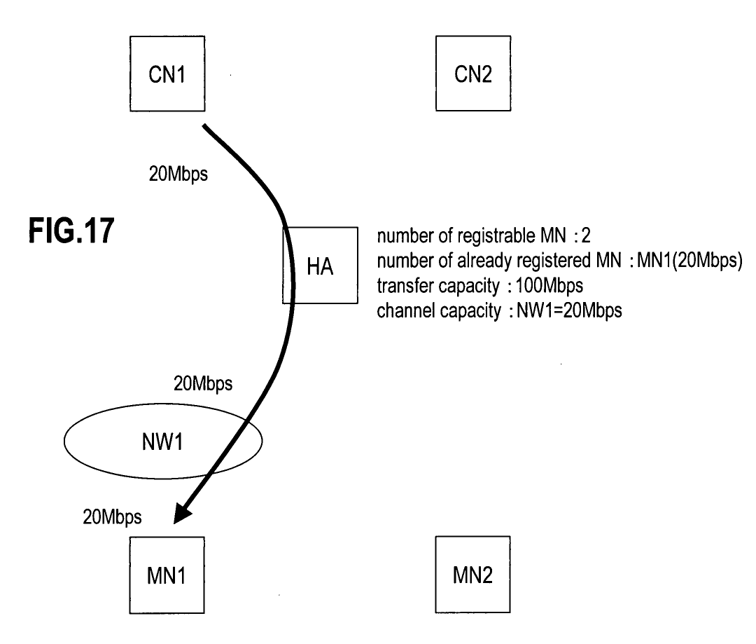

As a result, as shown in FIG. 17, only the communication traffic of 20 Mbps between the mobile node MN1 and the correspondent node CN1 passes through the home agent HA and the network NW1. Thus, it becomes possible to avoid communication quality deterioration caused by packet discard, etc. in the home agent HA and the network.

As such, when the home agent HA decides whether the registration request is acceptable, by taking not only the transfer capacity and the requested bandwidth but also the channel capacity into account, it becomes possible to support mobility of the mobile node MN, avoiding the occurrence of communication quality deterioration in the home agent HA and the mobile node MN.

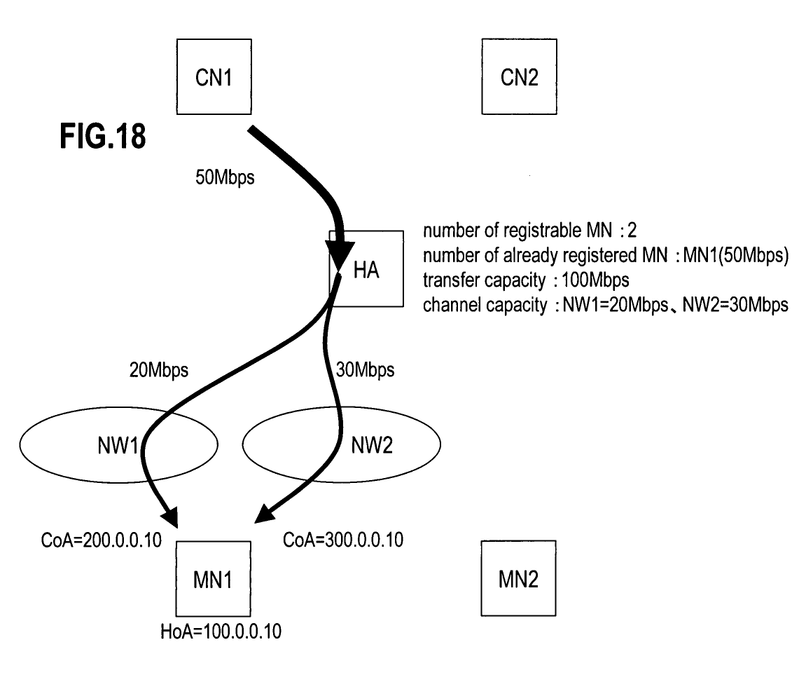

FIG. 18 shows an exemplary case that the mobile node MN1 is connected to the network using a plurality of communication channels. In this case, the mobile node MN1 uses two care-of addresses CoA, 200.0.0.10 and 300.0.0.10, on the network NW1 side and the network NW2 side, respectively. Each care-of address CoA is registered in the home agent HA. As an example, a cellular network is used as the network NW1, and a wireless LAN is used as the network NW2.

The home agent HA distributes and transfers 50 Mbps traffic from the correspondent node CN1 according to the channel capacity of the network NW1 and the network NW2 (here, 20 Mbps and 30 Mbps, respectively). By using such a plurality of communication channels, it becomes possible to transfer a large amount of traffic which cannot be transferred using the channel capacity of a single communication channel, without producing communication quality deterioration in the home agent HA and the communication channels.

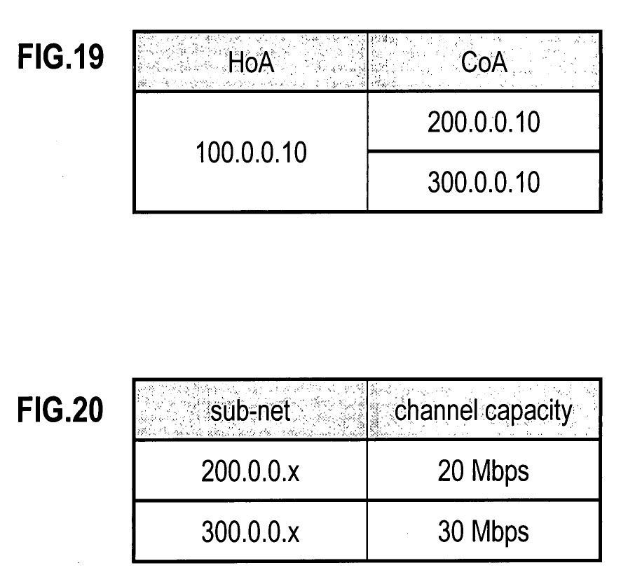

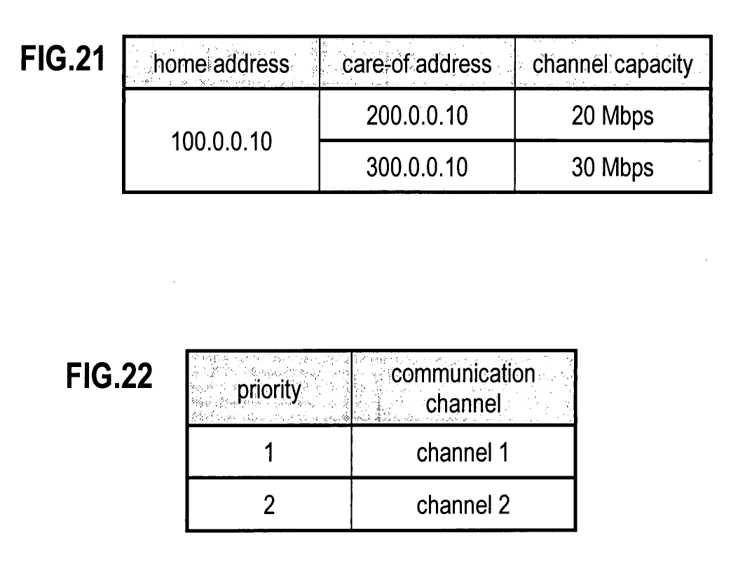

FIGS. 19, 20 show examples of a table retaining channel capacity information for each network separately from a binding cache including two care-of addresses CoA. FIG. 21 shows an example of a table retaining the binding cache BC and the channel capacity information in an integrated form. Further, FIG. 22 shows an example of a table retaining the priority of the communication channels used by the mobile node MN1 in the self-mobile node MN1.

A method may be considered such that the mobile node MN tries registration requests in order from a communication channel of the highest priority. For example, the above method may be used for selecting a channel when there are a plurality of channels each having a capacity satisfying a certain requested bandwidth, or for selecting a channel to be used first when it is required to flow a large amount of traffic, to the possible extent, using a plurality of communication channels simultaneously.

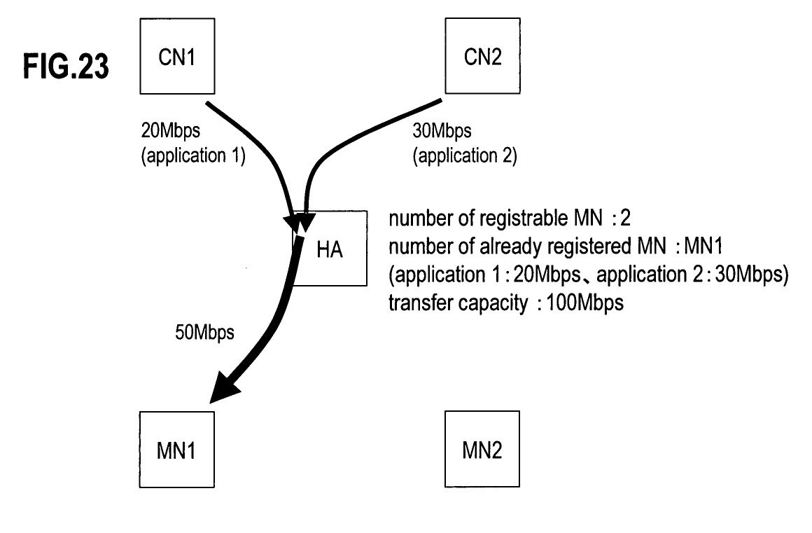

FIG. 23 shows an exemplary case that the mobile node MN1 executes a plurality of communication applications. In this case, the mobile node MN1 performs two communications of 20 Mbps and 30 Mbps with the correspondent node CN1 and the correspondent node CN2, respectively. For each communication, the mobile node MN1 initiates a registration request to the home agent HA. For each registration request, the home agent HA decides whether the request is acceptable or not, based on the transfer capacity, the already accepted bandwidths, and the requested bandwidth for the application.

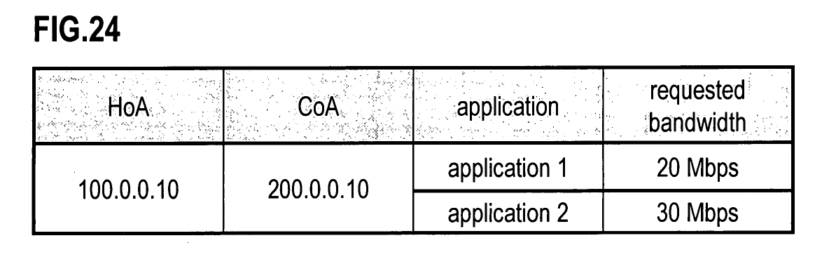

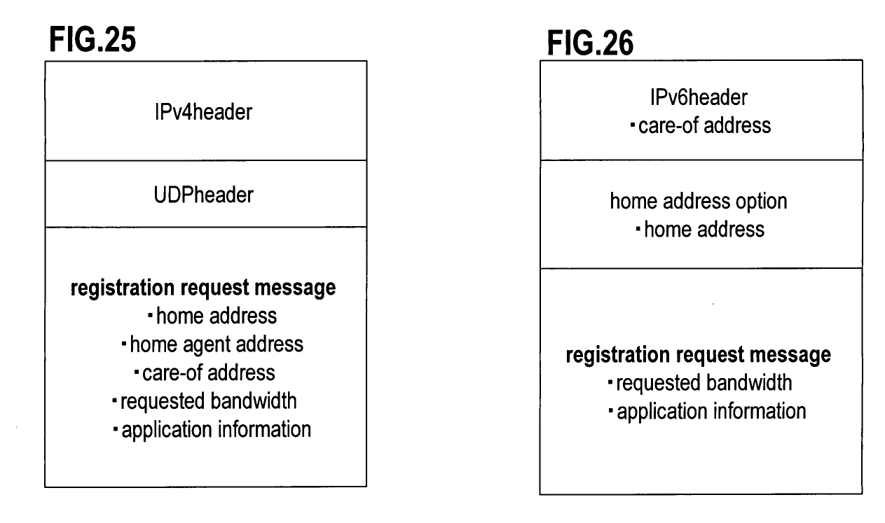

FIG. 24 shows an example of the binding cache BC generated at this time. As examples of information indicating applications (for example, file transfer using FTP and streaming), a TCP/UDP port number used by the application may be considered. FIGS. 25, 26 show examples of registration request messages including application information, in the cases of Mobile IPv4 and Mobile IPv6, respectively. The message includes a port number field as application information.

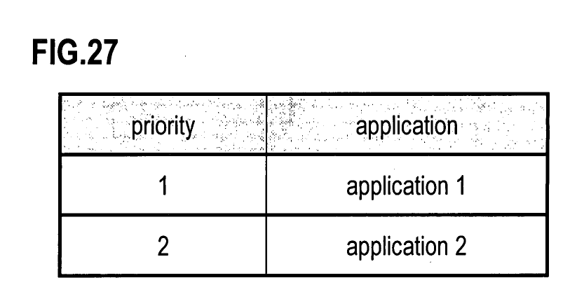

Further, FIG. 27 shows an example of an application priority table which the mobile node MN1 requests to register. This priority table is retained in the self-mobile node MN1. Based on the priority, it may be considered that the mobile node MN1 tries to initiate the registration request in order from the application having the highest priority. With this, for example, the higher the application priority is, the higher the success probability of registration acceptance by the home agent HA can be expected, even when the total requested bandwidths of a plurality of applications cause a shortage of the transfer capacity in the home agent HA.

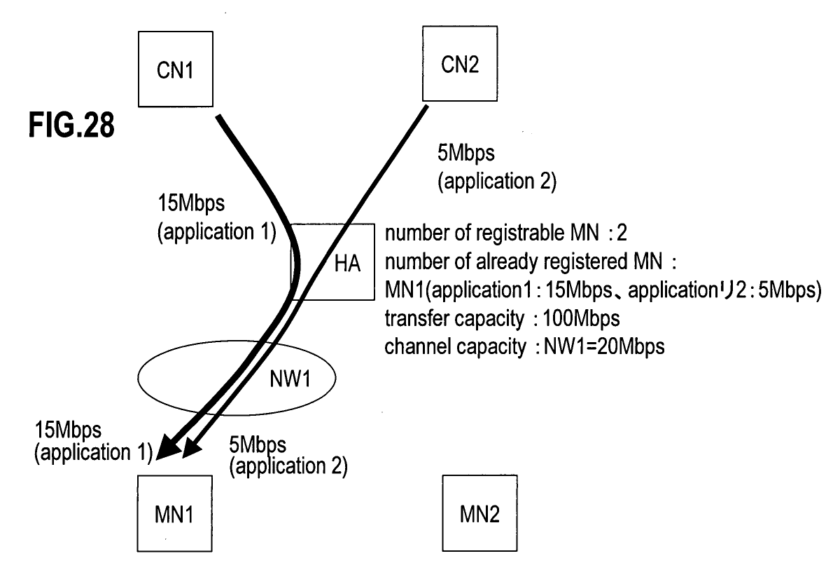

FIG. 28 shows an exemplary case of using a plurality of applications further, taking communication channel capacity into account. The mobile node MN1 initiates registration requests to the home agent HA for the communication with the correspondent node CN1 in regard to an application 1, and for the communication with the correspondent node CN2 in regard to an application 2, respectively.

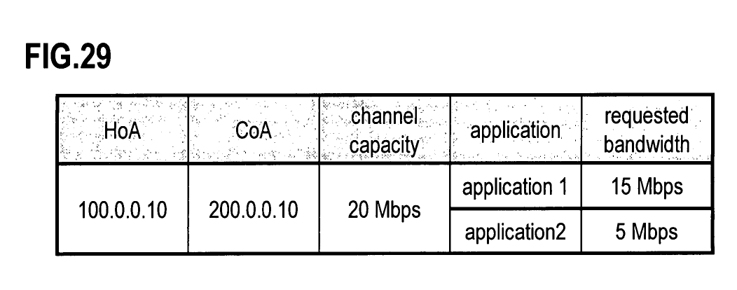

The home agent HA permits the registration when the channel capacity satisfies the requested bandwidth and the transfer capacity is sufficient, for each registration request on an application-by-application basis. With this, communication on the application basis can be performed without exceeding the transfer capacity of the home agent HA and the channel capacity of the communication channel. FIG. 29 shows an example of a binding cache BC generated at this time.

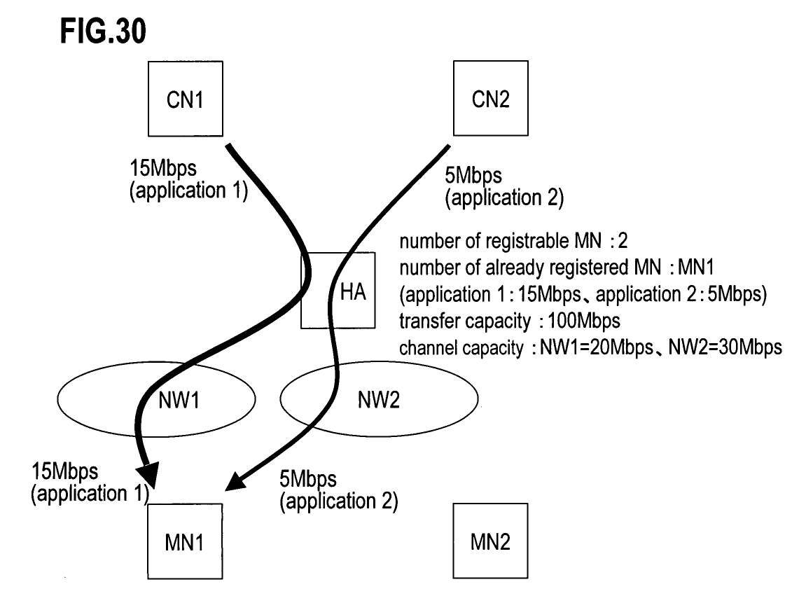

FIG. 30 shows an exemplary case of using a plurality of applications through a plurality of communication channels, taking the channel capacity of each communication channel into account. In this example, the mobile node MN1 initiates registration requests to the home agent HA for the communication with the correspondent node CN1 via the network NW1 in regard to the application 1, and for the communication with the correspondent node CN2 via the network NW2 in regard to the application 2, respectively.

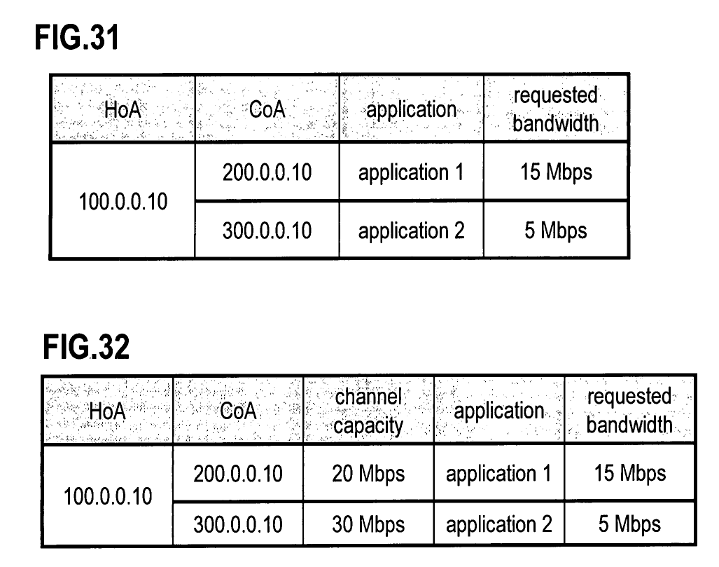

The home agent HA permits the registration when the channel capacity satisfies the requested bandwidth and the transfer capacity is sufficient, for each registration request on an application-by-application basis. With this, communication can be performed on the application basis using desired communication channels, without exceeding the transfer capacity of the home agent HA and the channel capacity of each communication channel. FIGS. 31, 32 show examples of generating a binding cache BC at this time. Here, FIG. 31 is a case that the channel capacity information as shown in FIG. 20 is retained individually, while FIG. 32 is a case that the channel capacity information is integrated into the binding cache BC.

In FIG. 32, the channel capacity is stored into the home agent HA when it is informed from the corresponding mobile node MN.

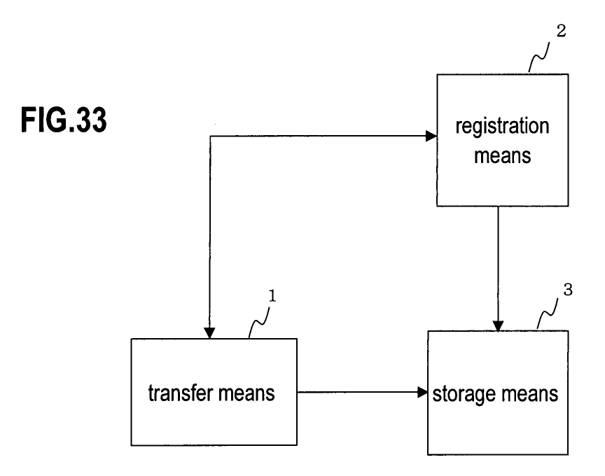

FIG. 33 shows an exemplary configuration of the home agent HA according to the present invention, which is commonly applicable to the embodiments described above.

A transfer means (unit) 1 performs packet identification including whether a packet is a user data packet or a registration request message, and also performs packet transmission and reception. When the registration request message is detected, the transfer unit 1 notifies a registration means (unit) 2, and requests the relevant processing. Further, as to packet transmission and reception, the transfer unit 1 refers to the binding cache BC stored in a storage means (unit) 3, encapsulates a packet destined to the home address HoA of the mobile node MN with a care-of address CoA, and then transfers the encapsulated packet.

Further, when the mobile node MN uses a plurality of applications, the transfer unit 1 performs transfer processing after identifying an application from a port number in the packet. Also, it may be considered that the transfer unit 1 does not transfer a packet of which home address HoA and application are not registered in the binding cache BC, and instead, discards the packet concerned.

Registration unit 2 decides whether or not the registration request is acceptable on the basis of the information including: a requested bandwidth included in the registration request message, the number of registrable mobile nodes MN in the home agent HA, the number of already registered mobile nodes MN, the transfer capacity, the already accepted bandwidths, and the channel capacity information. When the registration acceptance is completed, the registration unit 2 returns a registration reply message to the mobile node MN through the transfer unit 1, and also informs the storage unit 3 of necessary parameters, so as to request to generate a binding cache BC.

The storage unit 3 then stores the binding cache BC in regard to the mobile node MN, of which registration is permitted. Further, it may be considered that the storage unit 3 stores information including the transfer capacity of the home agent HA and the channel capacity for each network.

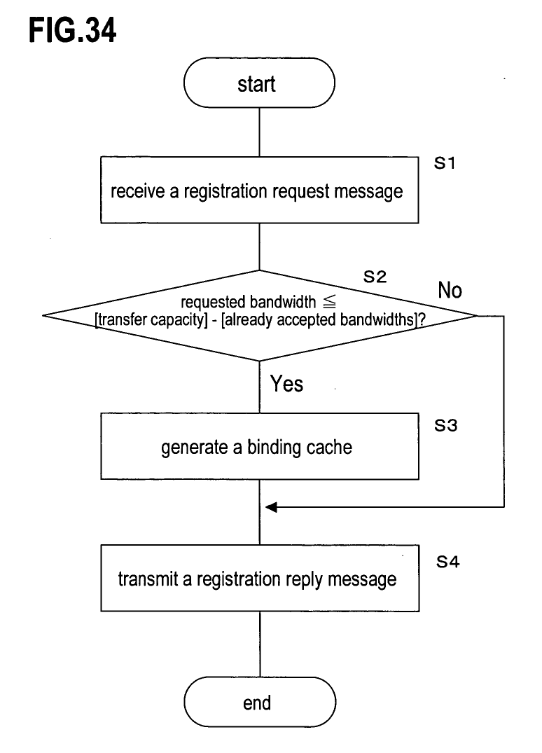

FIG. 34 shows a flowchart diagram when the registration processing as shown in FIG. 5 is performed in the home agent HA having the exemplary configuration shown in FIG. 33. Each operation step is explained in the following.

Transfer unit 1 receives and identifies the registration request message (step S1). Next, registration unit 2 decides whether the remainder of subtracting the already accepted bandwidths from the transfer capacity satisfies the requested bandwidth (step S2).

When registration unit 2 permits the registration (‘Yes’ in step S2), a binding cache BC is generated in storage unit 3 (step S3). When registration unit 2 rejects the registration, the binding cache BC is not generated (‘No’ in step S2).

Registration unit 2 then generates a registration reply message indicating the decision result of whether or not the request is registrable. The generated registration reply message is returned from the transfer unit to the mobile node MN (step S4).

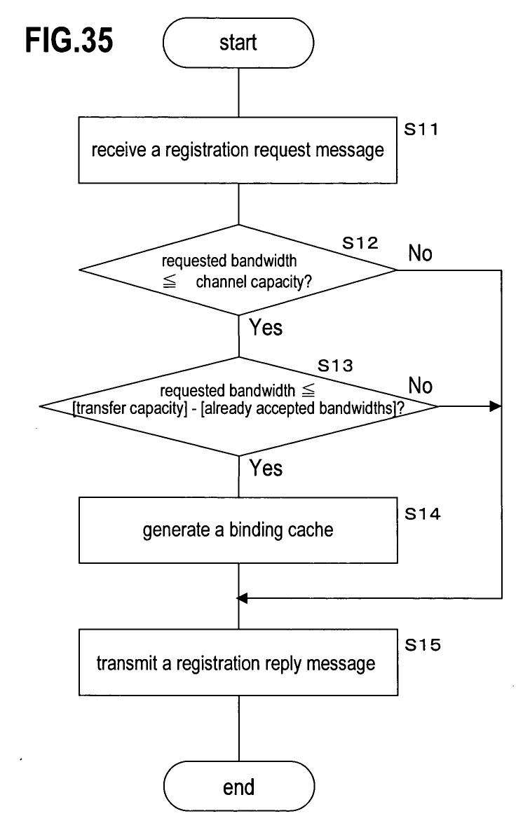

FIG. 35 shows a flowchart diagram when the registration processing in the embodiments shown in FIGS. 11, 15 is performed in the home agent HA having the exemplary configuration shown in FIG. 33. Each operation step is explained in the following.

Transfer unit 1 receives and identifies the registration request message (step S11). Next, registration unit 2 decides whether the channel capacity satisfies the requested bandwidth (step S12).

Further, registration unit 2 decides whether the remainder of subtracting the already accepted bandwidths from the transfer capacity satisfies the requested bandwidth (step S13). When registration unit 2 permits the registration, a binding cache BC is generated in storage unit 3 (step S14). On the other hand, when registration unit 2 rejects the registration (‘No’ in step S12), the binding cache BC is not generated.

When the decision result of whether or not the registration is acceptable is indicated, registration unit 2 generates and returns a registration reply message (step S15).

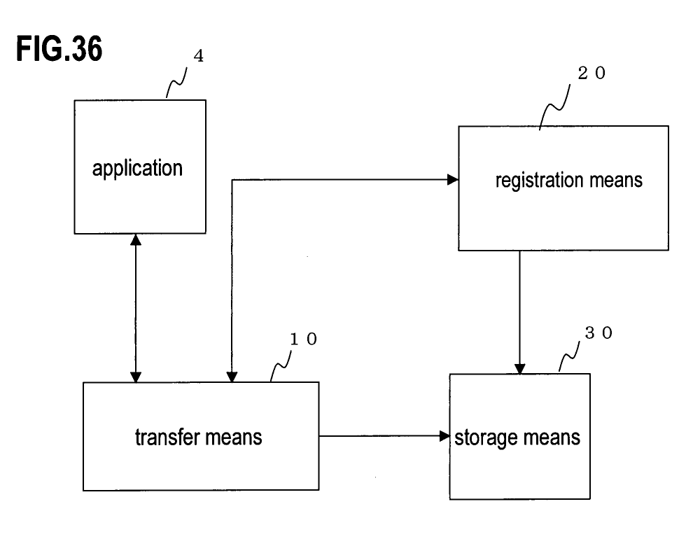

FIG. 36 shows an exemplary configuration of the mobile node MN according to the present invention.

An application 4 is a communication application used by a user. A transfer unit 10 performs identification and transmission/reception of user data packets related to application 4, and message packets such as a registration request and a registration reply. In regard to the packet transmission/reception, referring to the binding cache BC stored in storage unit 30, transfer unit 10 transmits a packet destined to the correspondent node by encapsulating the packet using the care-of address CoA, and also decapsulates a received packet tunneled through the home agent HA.

Further, when the mobile node MN uses a plurality of applications, transfer processing is performed after an application is identified from a port number of the packet.

Registration unit 20 generates a registration request message including required parameters such as the requested bandwidth, the channel capacity and the application information, and transmits the registration request message to the home agent HA. Further, in response to the registration result included in a registration reply message returned from the home agent HA, registration unit 20 informs storage unit 30 of necessary parameters, so as to request to generate a binding cache BC.

Storage unit 30 stores the binding cache BC which is generated when the registration is permitted. Also, it may be considered that storage unit 30 stores information such as the channel capacity and the communication channel priority in each network, and the application priority.

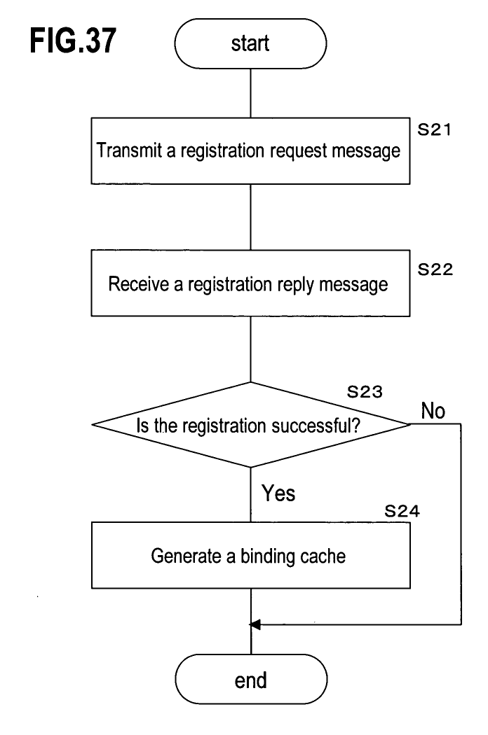

FIG. 37 shows a flowchart diagram when the registration processing in the embodiment shown in FIG. 5 is performed in the mobile node MN having the exemplary configuration shown in FIG. 36. Each operation step is explained in the following.

Registration unit 20 generates and transmits a registration request message (step S21).

Transfer unit 10 then receives and identifies the registration request message from the home agent HA (step S22)

In registration unit 20, when the registration is permitted (‘Yes’ in step S23), a binding cache BC is generated in storage unit 30 (step S24). Meanwhile, when the registration is rejected, the binding cache BC is not generated.

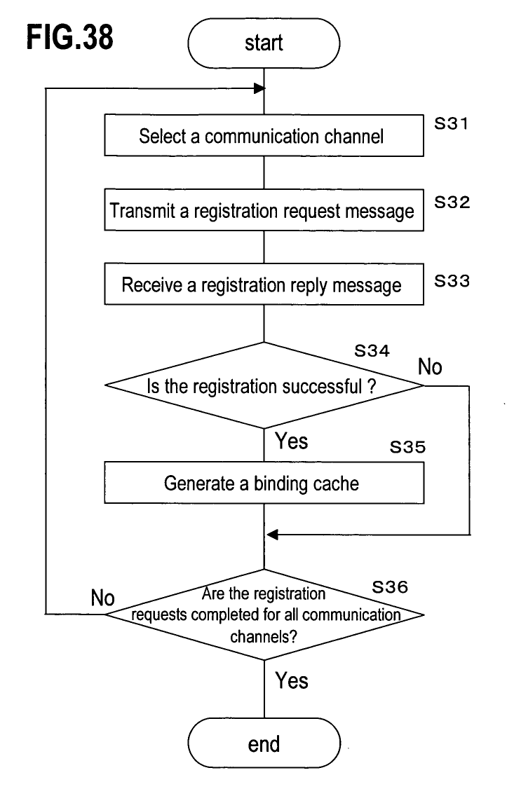

FIG. 38 shows a flowchart diagram when the registration processing explained in FIG. 18 is performed in the mobile node MN having an exemplary configuration shown in FIG. 36. Each operation step is explained in the following.

Registration unit 20 selects a communication channel for a registration request (step S31). A registration request message, which is selected and generated in registration unit 20, is then transmitted from transfer unit 10 to the home agent HA (step S32).

Meanwhile, transfer unit 10 receives and identifies a registration reply message from the home agent HA (step S33).

In registration unit 20, when the registration is permitted (‘Yes’ in step S34), a binding cache BC is generated in storage unit 30 (step S35). Meanwhile, when the registration is rejected, the binding cache BC is not generated.

When a communication channel requested for registration remains, the above-mentioned request operation is repeated for the communication channel concerned (step S36).

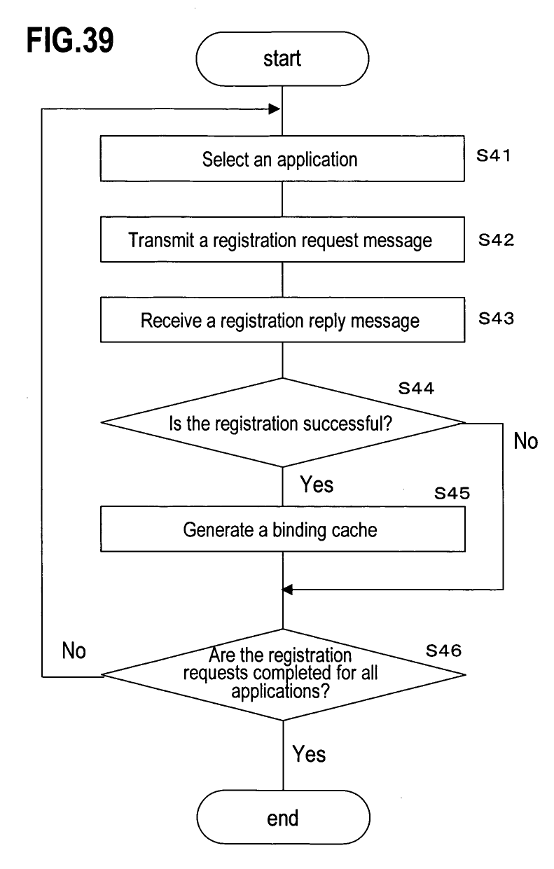

FIG. 39 shows a flowchart diagram when the registration processing explained in FIG. 23 is performed in the mobile node MN having an exemplary configuration shown in FIG. 36. Each operation step is explained in the following.

Registration unit 20 selects an application for requesting registration (step S41). Next, registration unit 20 generates and transmits a registration request message corresponding to the selected application (step S42).

Transfer unit 10 then receives and identifies a registration reply message from the home agent HA (step S43).

In registration unit 20, when the registration is permitted (‘Yes’ in step S44), a binding cache BC is generated in storage unit 30 (step S45). Meanwhile, when the registration is rejected, the binding cache BC is not generated.

When an application of which registration is requested remains, the above-mentioned request operation is repeated for the application concerned (step S46).

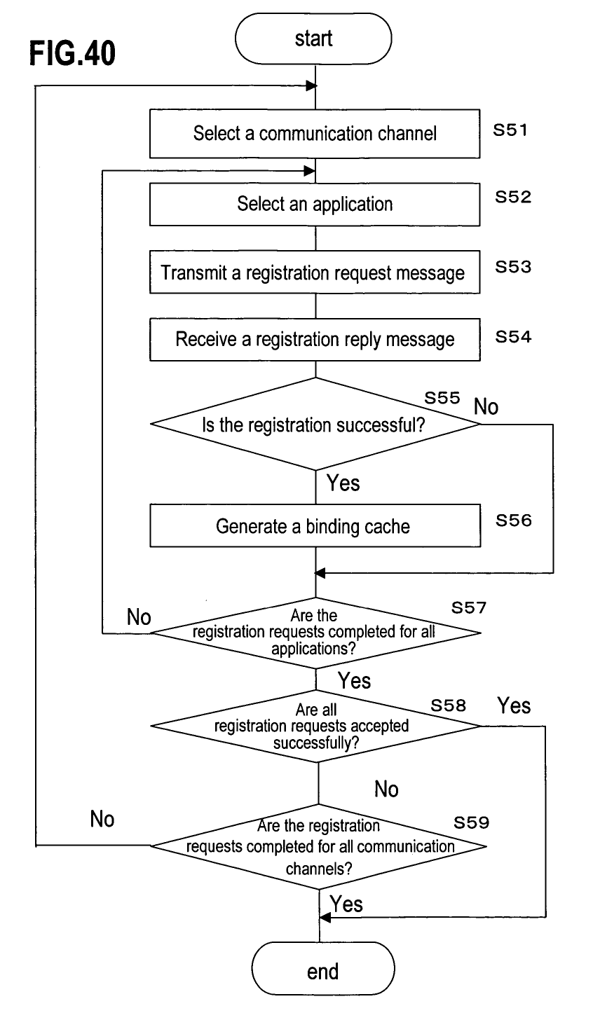

FIG. 40 shows a flowchart diagram when the registration processing explained in FIG. 30 is performed in the mobile node MN having an exemplary configuration shown in FIG. 36. Each operation step is explained in the following.

Registration unit 20 selects a communication channel of which registration is requested (step S51). Further, registration unit 20 selects an application of which registration is requested (step S52).

Registration unit 20 then generates a registration request message, so as to transmit via transfer unit 10 (step S53). Further, transfer unit 10 receives and identifies a registration reply message from the home agent HA (step S54).

In registration unit 20, when the registration is permitted (‘Yes’ in step S55), a binding cache BC is generated in storage unit 30 (step S56). Meanwhile, when the registration is rejected, the binding cache BC is not generated.

When an application of which registration is requested remains, the above-mentioned request operation is repeated for the application concerned (step S57). If the registration requests are completed for the entire applications, and all requests are accepted successfully, the process for the communication channel of interest is completed (step S58).

Furthermore, after registration requests are completed for the entire applications using one communication channel, if another communication channel of which registration is requested remains (‘No’ in step S58), the above-mentioned registration request operation is repeated for the applications using the other remaining communication channel (step S59).

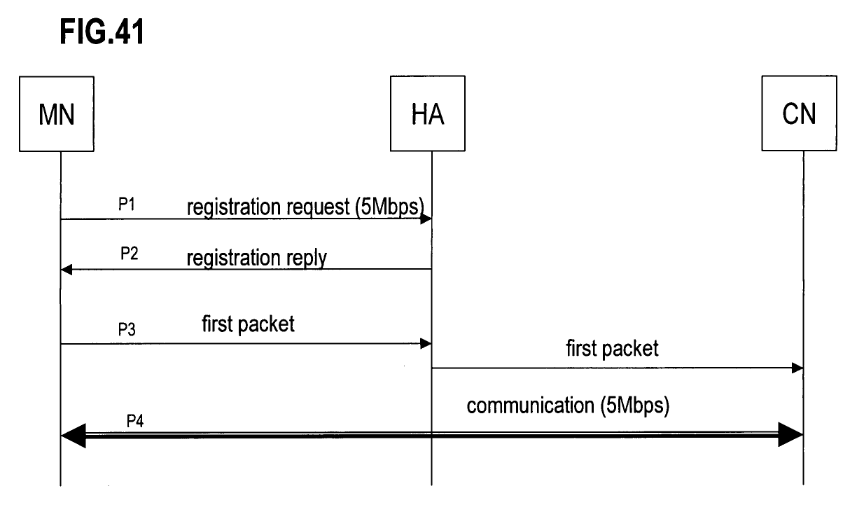

FIG. 41 shows a sequence diagram when the mobile node MN starts communication. The mobile node MN first initiates a registration request to the home agent HA, according to the requested bandwidth of the application to be used (here, 5 Mbps) (process P1). When the registration is permitted in the home agent HA, and a registration reply message is received in the mobile node MN (process P2), the mobile node MN transmits a first packet destined to the correspondent node CN via the home agent HA (process P3). Thus, the communication between the mobile node MN and the correspondent node CN is established, and packets are transmitted via the home agent HA (process P4).

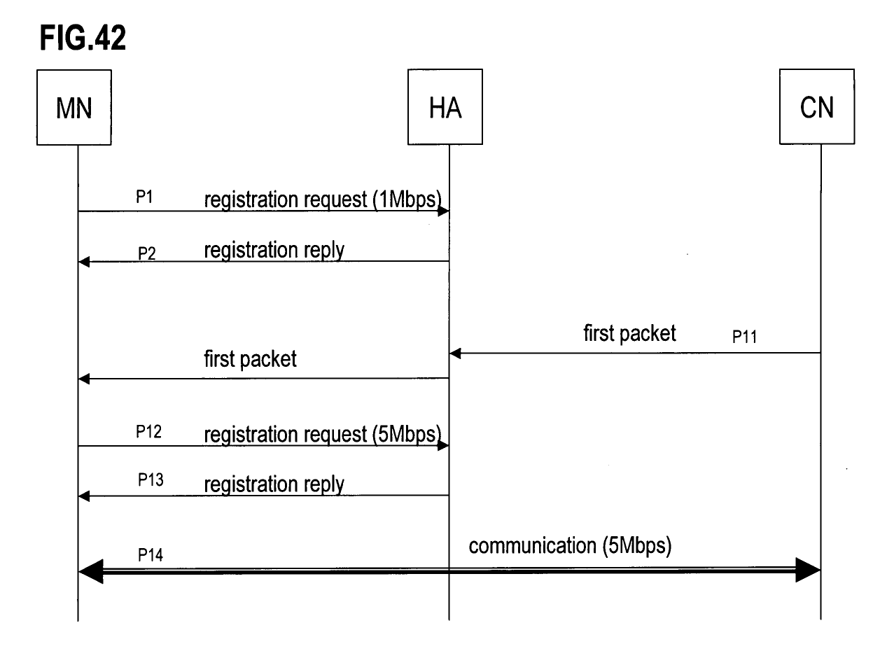

FIG. 42 shows a sequence diagram when the correspondent node CN starts communication. The mobile node MN performs in advance a first registration request to the home agent HA, with a comparatively small requested bandwidth (here, 1 Mbps), so that a first packet from the correspondent node CN can be received (processes P1, P2)

Thereafter, the communication is started in the correspondent node CN, and the first packet reaches the mobile node MN via the home agent HA (process P11). Next, based on the first packet received from the correspondent node CN, the mobile node MN starts to execute the application. At this time, the mobile node MN performs registration request operation to the home agent HA afresh, based on the requested bandwidth of the application (here, 5 Mbps) (process P12). When the registration is permitted in the home agent HA, and the mobile node MN receives a registration reply message (process P13), the mobile node MN transmits a response to the first packet received from the correspondent node CN. Thus, the communication between the mobile node MN and the correspondent node CN is established, and packets are transferred via the home agent HA (process P14).

As having been described, according to the present invention, it is possible to support mobility of the mobile node MN, avoiding the occurrence of communication quality deterioration. In particular, the above-mentioned feature of the present invention becomes effective because it is realized only by the home agent HA and the mobile node MN, at a reduced cost, without performing a lot of changes to the whole network. Further, location registration and transfer resource reservation in the home agent HA can be performed at a time, without increasing the number of messages. This can save a traffic amount, and shorten a necessary processing time. Therefore, it is very probable that the present invention will be applied for high-quality mobile services provided by communication carriers or service providers in mobile communication environments using portable equipment such as portable telephone, PDA (personal digital assistance) and notebook PC, being connected to the Internet out by switching a variety of wireless access networks.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A home agent in a mobile IP network comprising:
a storage unit storing an upper limit value of a throughput with which transfer processing can be performed, as self-transfer capacity information;
a registration unit deciding, based on bandwidth information requested for registration which is transmitted from a mobile node, whether or not the registration is acceptable by referring to the upper limit value of the throughput, with which transfer processing can be performed, being stored in the storage unit; and
a transfer unit transferring to a care-of address a packet destined to the mobile node which is decided registrable by the registration unit.

2. A home agent in a mobile IP network comprising:
a storage unit storing channel capacity information;
a registration unit deciding, based on bandwidth information requested for registration which is transmitted from a mobile node, whether or not the registration is acceptable by referring to the channel capacity information stored in the storage unit; and
a transfer unit transferring to a care-of address a packet destined to the mobile node which is decided registrable by the registration unit.

3. The home agent according to claim 2,
wherein the mobile node uses a plurality of applications, and when a registration request is initiated from the mobile node which uses the plurality of applications, the registration unit decides whether or not the registration is acceptable for each of the plurality of applications, based on the bandwidth information requested for registration.

4. The home agent according to claim 2,
wherein a registration is initiated from a mobile node using a plurality of communication channels, and
wherein, based on the requested bandwidth information and the channel capacity information, the registration unit decides whether or not the registration is acceptable by dividing the requested bandwidth for each of the plurality of channels.

5. The home agent according to claim 1,
wherein a registration is initiated from a mobile node which uses a plurality of communication channels and a plurality of applications, and the registration unit decides whether or not the registration is acceptable on an application-by-application basis, based on the requested bandwidth information and the channel capacity information.

6. The home agent according to claim 2,
wherein the channel capacity information of the communication channel to be stored in the storage unit is acquired from the mobile node.

7. The home agent according to claim 2,
wherein the registration unit discards a packet not satisfying a transfer condition which is decided registrable by the registration unit.

8. A mobile node in a mobile IP network comprising:
a registration unit generating a registration message including at least information of a requested bandwidth, and requesting the home agent to register; and
a storage unit storing a binding cache,
wherein, according to the result of a registration response from the home agent in response to the registration request to the home agent, the registration unit instructs the storage unit to generate and store a binding cache to be referred to at the time of packet transmission.

9. The mobile node according to claim 8,
wherein the registration message for initiating a registration request from the registration unit to the home agent further includes communication channel capacity information.

10. The mobile node according to claim 8,
wherein the registration message for initiating the registration request from the registration unit to the home agent further includes application information.

11. The mobile node according to claim 8,
wherein the mobile node uses a plurality of communication channels, and the registration unit registers to the home agent by use of a registration message including the information of the plurality of communication channels.

12. The mobile node according to claim 11,
wherein, according to the priority of the plurality of communication channels, the registration unit registers to the home agent by use of a registration message including communication channel information of the corresponding communication channel.

13. The mobile node according to claim 8,
wherein the mobile node uses a plurality of applications, and the registration unit registers to the home agent by use of a registration message including the requested bandwidth information and the application information.

14. The mobile node according to claim 13,
wherein, according to the priority of the plurality of applications, the registration unit registers to the home agent by use of a registration message including communication channel information of the corresponding communication channel.

15. A mobile IP network system including a home agent and a mobile node of which location is registered in the home agent,
wherein the home agent comprises:
a storage unit storing channel capacity information;
a registration unit deciding, based on the bandwidth information requested for registration which is transmitted from the mobile node, whether or not the registration is acceptable by referring to the channel capacity information stored in the storage unit; and
a transfer unit transferring to a care-of address a packet destined to the mobile node which is decided registrable by the registration unit, and
the mobile node comprises:
a registration unit generating a registration message including at least the requested bandwidth information, and requesting the home agent to register; and
a storage unit storing a binding cache,
wherein, according to the result of a registration response from the home agent in response to the registration request to the home agent, the registration unit instructs the storage unit to generate and store a binding cache to be referred to at the time of packet transmission.
